(19) United States
(12) Patent Application Publication
(10) Pub. No.: US 2025/0222704 A1
(43) Pub. Date: Jul. 10, 2025

(54) HIGH VOLUME DIGITAL GARMENT PRINTER

(71) Applicant: Kornit Digital Ltd., Rosh HaAyin (IL)

(72) Inventors: Alon POLAKEVICH, Pardes Hanna (IL); Abraham BENSADIGH, Tel Aviv (IL); Daniel POSTO, Rosh HaAyin (IL); Shay SAHAR, Kibbutz Gat (IL); Pavel KOROLIK, Petah Tikva (IL); Ehud MALENKOVICH PAZ, Netanya (IL); Nadav MORDECHAI, Tel Aviv (IL); Efraim YOHANANI NAFTALI, Rishon-LeZion (IL); Yinnon BOOKS, Tel Aviv (IL)

(73) Assignee: Kornit Digital Ltd., Rosh HaAyin (IL)

(21) Appl. No.: 18/853,727

(22) PCT Filed: Apr. 4, 2023
(86) PCT No.: PCT/IL2023/050369

§ 371 Date: Oct. 3, 2024

Related U.S. Application Data
(60) Provisional application No. 63/326,969, filed on Apr. 4, 2022.

(51) Int. Cl. B41J 13/08; B41J 3/407; B41J 11/00; B41J 13/22; B65G 47/90; D06P 5/20

(52) U.S. Cl. CPC B41J 13/08; B41J 3/4078; B41J 11/002; B41J 11/0095; B41J 13/22; B65G 47/90; D06P 5/2077; B65G 2201/0229

(57) ABSTRACT

A digital garment printing system for printing and drying of garments comprises a loading station for loading garments for printing onto pallets, a conveyor, at least one printing functional unit, an unloading station, a dryer; and a drying belt for carrying the garments through the dryer after printing, wherein the unloading station comprises an automatic unloader for removing the garments from pallets and placing the garments on said drying belt.

### RELATED APPLICATIONS

This application claims the benefit of priority under 35 USC § 119 (e) of U.S. Provisional Patent Application No. 63/326,969 filed Apr. 4, 2022, the contents of which are incorporated herein by reference in their entirety.

### FIELD AND BACKGROUND OF THE INVENTION

The present invention, in some embodiments thereof, relates to a high volume digital garment printer.

As the demand for digital printers rises, there is a need for higher volume production lines with better operation, and more economic and sustainable characteristics.

For this purpose, the next generation of direct to garment (DTG) digital printers may be expected to be faster, in terms of more prints per hour, automated load and unload of the garments, cheaper to operate, in terms of fewer manual operations, minimum man-in-the-loop activities, minimum footprint, smaller ink consumption, flexible, in terms of support of different types and sizes of garments, support of different designs and sizes of the printed images, may be scalable, that is to say can support a single printer to a full fleet or factory with smart load balancing, and further should be modular in that each printer may be adjusted to specific needs by adding or removing specific modules.

In addition, as the industry turns to a more holistic approach with full connectivity and automation, there is a growing need and justification for a full solution perception, rather than a combination of standalone subsystems. In the printer's world that should cover as much as possible of the printed garment manufacturing cycle, including the garment or media storage, handling, loading, image printing, neck-tag printing, drying, unloading, folding, and packaging.

So instead of having separate systems for each phase in the process, with very loose integration between them, and separate human operators to operate them, the new approach concentrates on a full integrated system and includes as many as possible of the functional systems and with minimum operators.

Furthermore, such an all-in-one system may be flexible and modular to allow the manufacturer to configure it in direct accordance with his needs. That is to say it should be easy to remove parts that he already has and/or add parts that he needs to upgrade.

To summarize, there is a strong need for a true mass-production digital DTG printer with the capability to expend and add additional functions to the manufacturing cycle.

The current mass-production lines for digital printed textile are commonly based on multiple print lines each using small-to-medium volume production systems that is the printer with additional facilities in their vicinity (e.g., storage, common dryers, etc.).

For example, a factory with a low production volume (orders) of around 1000 shirts per day may use one printer and one dryer, which between them may handle approx. 100 shirts per hour over a 10-hour shift. If the orders are of medium volume of around 10,000 per day, the production line may need ten such printers operating in parallel. Several printers may use a single dryer as shown in FIG. 1, where three production cells are formed, each having three printers and one dryer. The shirts need to be loaded on the printers and then transferred to the dryers.

Note that since printing requires very precise registration, and the dryers are very hot, it is not possible to use the same pallets to carry the shirts directly from the printers to the dryer. Rather the shirts have to be unloaded from the very precise pallets used by the printer and then transferred to the dryers. The pallets may often contain a neck-tag printing surface which may require some kind of release in order to free the shirts.

This straightforward solution is very costly in both plant footprint of the equipment that is the factory floor area required for all the printers and dryers, and the manpower to operate it, since each printer requires at least one human operator for its entire operation duration.

For a true mass-production factory, say over 10,000 printed shirts per day, the required area and number of human operators become very significant to the entire economical model of the plant.

The system of FIG. 1 requires excessive factory floor area. Specifically, printers are scattered around a large working space, resulting in high overhead to approach them, deliver inks and parts, maintain them and so forth.

Significant distance between the printer and its related dryer causes additional time overhead to reach the dryers with the now unloaded shirts and then return to the printer. As a result many operators are needed per shift, that is at least one operator for each printer, and some of these operators may be redundant over slower shifts with lower amounts of printing to do. On the other hand, when there is a high workload, the system operators have to load and unload the garments manually, and thus become the main bottleneck for mass production.

With the current solution of scale-up by additional printers, a typical factory based on state of the art printers is limited in its manufacturing capacity and not flexible enough to handle all optional magnitudes of orders. Yet integration between the printers and the dryers is not possible because the high precision printing pallets cannot be fed into the dryers.

### SUMMARY OF THE INVENTION

The present embodiments relate to interfacing between the printing part of the system and the drying part of the system so that garments are automatically fed from printing to drying. This may be achieved by an automatic unloader that removes garments from the printing pallets, including releasing the neck-tag printing surface when applicable, and places them on a drying belt, and may further involve coordination of the printing speed with the drying speed, which is to say the speed of the drying belt. In embodiments, the loading and unloading of pallets are carried out at the same end of the conveyor, that is on the same side of the printing unit, and thus a two part conveyor system may be used, where one part of the conveyor takes the pallets with the garments from loading to printing and the other part takes the pallets back to the loading area. The two conveyor parts may be side by side or one under the other.

According to an aspect of some embodiments of the present invention there is provided a digital garment printing system for printing and drying of garments comprising:
a loading station for loading garments for printing onto pallets;
a conveyor;
at least one printing functional unit;
an unloading station;
a dryer; and
a drying belt for carrying the garments through the dryer after printing, wherein the unloading station comprises an automatic unloader for removing the garments from pallets and placing the garments on the drying belt. The unloader may include a feature for releasing a neck tag if applicable.

In embodiments, the loading station and the unloading station are on a same side of the printing functional unit.

In embodiments, the conveyor comprises an upper conveyor and a lower conveyor, the system further comprising up lift for raising a pallet from the lower conveyor to the upper conveyor and a down lift for lowering a pallet from the upper conveyor to the lower conveyor, the up lift and the down lift being at respectively opposite sides of the printing functional unit and the upper conveyor and the lower conveyor each extending between the up lift and the down lift.

In embodiments, the drying belt has a width to accommodate a first number of garments, the first number being greater than one, the drying belt being set at a speed to advance by one garment width during the time that the first number of garments is provided from the printing functional unit, thereby coordinating a drying speed with a printing speed.

In embodiments, the drying belt is configured to advance continuously and the automatic unloader is configured to place successive garments at succeeding locations across the drying belt.

In embodiments, a length of the dryer is selected to provide garments a predetermined drying time when advancing through the drying on the drying belt at the drying speed.

Embodiments may comprise a pallet resizing station, wherein pallets are altered in configuration to fit given garments.

Embodiments may include heating and curing compartments in the dryer, the heating and curing compartments operating at respectively different temperatures.

Embodiments may comprise a further printing functional unit located on the lower conveyor.

Embodiments may comprise a reader, such as a barcode reader, or an RFID reader, for reading data supplied with garments, or an automatic system to identify the garment's type by its main characteristics, thereby to print each garment in accordance with the data.

The automatic unloader may include a gripper which is extended to release a neck-tag printing mechanism prior to unloading the garment from the pallet.

According to a second aspect of the present invention there is provided a high speed digital garment printing method for printing and drying of garments comprising:
loading garments for printing onto pallets;
conveying the garments to a printing functional unit for printing;
as necessary releasing the garment's neck-tag from the pallet;
unloading the garments from the pallets and placing onto a drying belt; and
drying the garments, wherein a speed of the drying belt is coordinated with garment printing production of the printing functional unit.

The method may include loading and unloading on a same side of the printing functional unit.

The method may include raising a pallet from a lower conveyor to an upper conveyor lowering a pallet from the upper conveyor to the lower conveyor, sad raising and the lowering being at respectively opposite sides of the printing functional unit.

In embodiments of the method, the drying belt has a width to accommodate a first number of garments, the first number being greater than one, and setting the drying belt at a speed to advance by one garment width during the time that the first number of garments is provided from the printing functional unit, thereby coordinating a drying speed with a printing speed.

The method may include advancing the drying belt continuously and placing successive garments at succeeding locations across the drying belt.

In embodiments of the method, a length of the dryer is selected to provide garments a predetermined drying time when advancing through the drying on the drying belt at the drying speed.

The method may include altering a pallet configuration to fit given garments.

The method may include operating separate heating and curing compartments in the dryer at respectively different temperatures.

The method may include carrying out a printing or drying or deposition function on the lower conveyor.

The method may include reading data supplied with garments thereby to print each garment in accordance with the data.

Garments may be automatically or semi automatically loaded from a stack to the printing pallet, using a loader.

According to a third aspect of the present embodiments there is provided a digital garment printing system for printing of garments comprising:
a loading station for loading garments for printing onto pallets;
a conveyor;
at least one printing functional unit;
wherein the conveyor comprises an upper conveyor and a lower conveyor, the system further comprising an up lift for raising a pallet from the lower conveyor to the upper conveyor and a down lift for lowering a pallet from the upper conveyor to the lower conveyor, the up lift and the down lift being at respectively opposite sides of the printing functional unit and the upper conveyor and the lower conveyor each extending between the up lift and the down lift wherein the lower conveyor comprising a second functional unit.

In an embodiment the second functional unit is at least one member of the group consisting of a printing station, a drying station and a deposition station.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagram illustrating prior art high throughput printing systems;

FIGS. 2a and 2b are a side view and a view from above respectively, of blocks of a printing system according to embodiments of the present invention;

FIGS. 3a and 3b are a side view and a view from above respectively, of blocks of a printing system according to another embodiment of the present invention;

FIG. 4 is a simplified drawings giving a perspective view of a printing system according to embodiments of the present invention;

FIG. 5 is a view from above of a printing system according to an embodiment of the present invention;

FIG. 6 is a more detailed view of the embodiment of FIG. 5;

FIG. 7 is a side view showing how a garment for printing may move through the stations of a printing system according to embodiments of the present invention;

FIG. 8 is a simplified view from above of an interface between a printing and part and a drying part of a printing system according to embodiments of the present invention;

FIG. 9 is a simplified diagram showing the interface of FIG. 8 from a perspective view, with parts cut away;

FIGS. 10A-10D are simplified diagrams showing an unloader device on a rail together with a neck tag printing pallet extension, according to embodiments of the present invention;

FIG. 11 is a simplified diagram showing an integrated barcode reader according to embodiments of the present invention; and

FIG. 12 is a simplified diagram showing an excess fluid management system for printing pallets according to embodiments of the present invention.

### DESCRIPTION OF SPECIFIC EMBODIMENTS OF THE INVENTION

The present invention, in some embodiments thereof, relates to a high volume digital garment printer and, more particularly, but not exclusively, to a high volume automated digital printer for textile garments based on an over-and-under pallet conveying system with lifts on both sides, return conveyer with or without functionality and optional functional modules in between. The conveying system is connected to an associated dryer using a garment unloader with pick and place capability to place the garments in optimized manner for drying.

A digital garment printing system for printing and drying of garments comprises a loading station for loading garments for printing onto pallets, a conveyor, at least one printing functional unit, an unloading station, a dryer; and a drying belt for carrying the garments through the dryer after printing, wherein the unloading station comprises an automatic unloader for removing the garments from pallets and placing the garments on said drying belt. If applicable, the automatic unloader may include a feature for releasing the garment's neck-tag,

The conveyor may be arranged over two levels, with pallet lifting mechanisms on both sides to raise and lower the pallet. A horizontal moving conveyer may return the carriages to the loading/unloading station with or without the printed media onboard. An embodiment may have at least one garment loading and/or unloading station and at least one garment printing station.

Additional functional modules within the apparatus may include a manual or automatic garment loader and unloader, pallet size and shape fitting, wet and/or dry pretreatment, white and/or color printing, visual inspection, garment identification, neck-tag printing, additional decoration, post print drying and/or curing within the conveying path and/or as a separate attached module, and garments picker/folder/packager. Garment identification may utilize a barcode and/or dedicated sensors to detect the garment type and characteristics.

Embodiments may relate to a system, sequence, and workflow, and may be useful for any digital printing on textile, either for multiple copies or for one-offs.

The present embodiments may use an over and under architecture for the conveyor, where two conveyor levels are combined with elevators at either end for transferring the printing pallets between one level and the other.

In the present embodiments, a feature lies in the position of the unloading module, which may be located at the same side as the loading station. Such an arrangement means that the pallets return to the loading station below the main conveying system, with the printed shirts onboard, instead of after offloading the printed shirts.

The present embodiments may provide an interface, for example a smart interface, to an adaptive inline dryer, where transfer of the printed media may be carried out using an automatic unloader.

These changes may allow a better utilization of the footprint alongside with improved ergonomics.

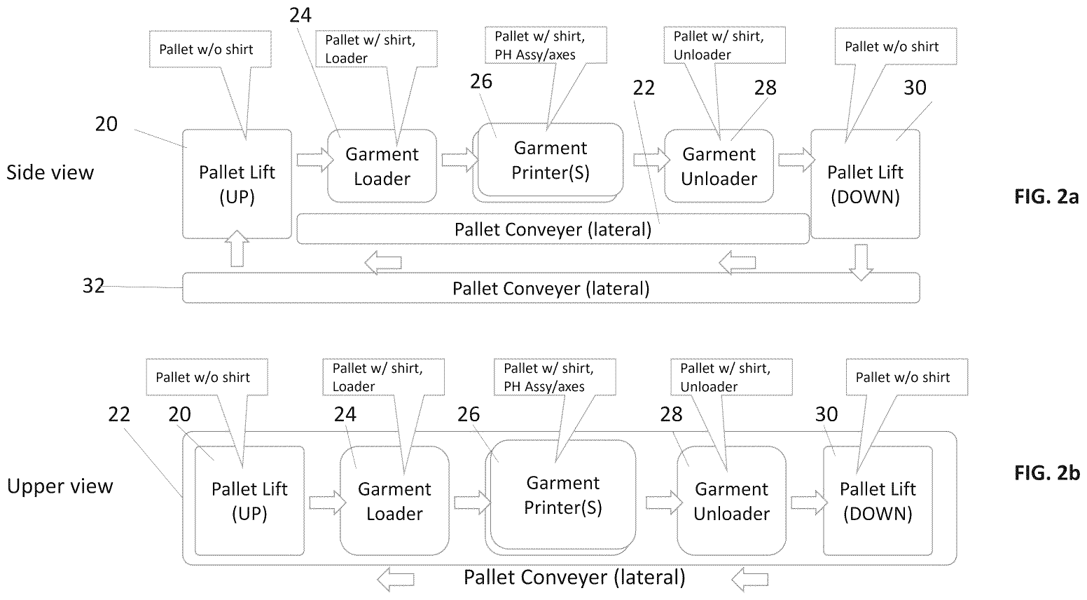

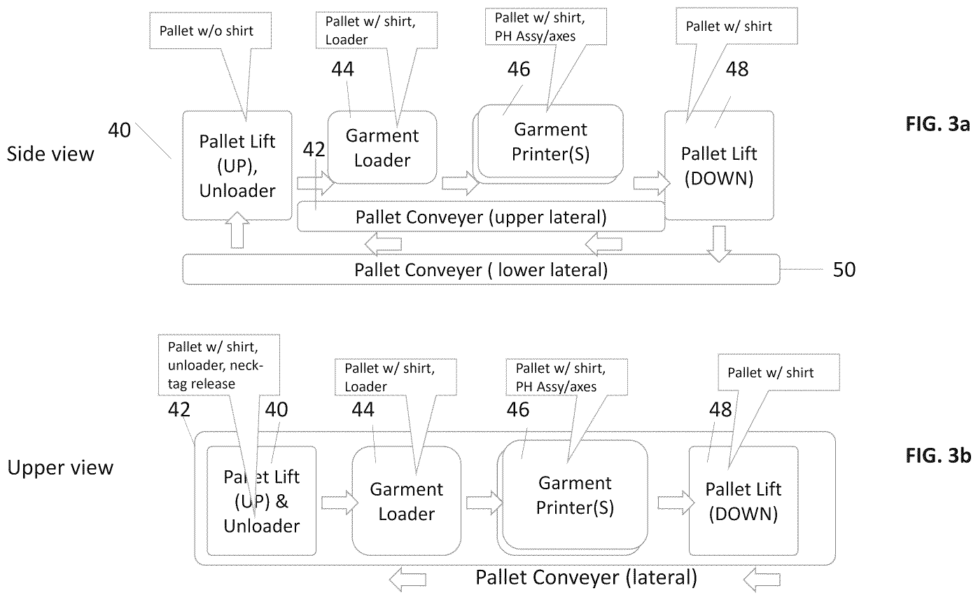

As mentioned, the loading station and the unloading station may be on different sides of the printing functional unit-see FIGS. 2a and 2b below, or may be on the same side of the printing functional unit see FIGS. 3a and 3b below.

The conveyor may comprise an upper conveyor and a lower conveyor. An up lift may raise a pallet from the lower conveyor to the upper conveyor and a down lift may lower a pallet from the upper conveyor to the lower conveyor. The up lift and the down lifts may be at respectively opposite sides of the printing functional unit and the upper conveyor and lower conveyor may each extend between the up lift and the down lift.

The drying belt may have a width to accommodate a certain number of garments, the number being greater than one. The drying belt may be set at a speed to advance by one garment width during the time that the number of garments is provided from the printing functional unit, thereby coordinating a drying speed with a printing speed. Thus if the width is three garments, then the belt advances by one garment width over the time that three garments are printed.

The drying belt may advance continuously and the automatic unloader places successive garments at succeeding locations across the drying belt as it advances, creating a staggering effect.

The dryer is of a length so as to provide garments a predetermined drying time when advancing through the dryer on the belt at the drying speed. Thus if one shirt is provided every nine seconds and the width of the belt accommodates three shirts, then the belt advances by one shirt width every 27 seconds. Typical drying times may be of the order of four minutes.

The pallets may be flexible pallets which can be resize or reconfigured for different kinds of garments. A pallet resizing station may be included at which the pallets are altered in configuration to fit given garments.

The system may include separate heating and curing compartments in the dryer. The heating and curing compartments may operate at respectively different temperatures to carry out their different functions.

The system may include further functional units located on the lower conveyor. The lower conveyor may not have all the mechanics needed for precise positioning of the pallets so the position may be reserved for functions that do not require highly precise positioning. Such low precision functions may include deposition of post-printing materials, and pre-drying by infrared or other means.

The system may use a reader for reading data that is supplied with the garments, such as barcodes or RFIDs. The readers may be embedded within the system, in contrast with manually operated readers that are commonly used in front of the loading station, and may establish the information of the next (N+1) shirt with plenty of time to allocate and load necessary job data. The data may define the desired printing operation, for example indicating the material of the garment, the size or type of the garment and the print file to be used for printing. Accordingly, the data may be used to print each garment as needed in automatic fashion.

The present embodiments may thus provide printing system for high volume digital printing where modules provide required functions. There may be provided automatic or semi-automatic loading of garments, for example from a stack of garments, automatic release of the garment from any specific mounting device in the pallet such as a neck tag surface, automatic unloading of garments which may be directly to an inline high-volume dryer, adaptive multi-lane dryer with full integration to the printer by automatic unloading, and there may be provided an automatic pallet resizing mechanism to support multiple garment types and sizes without human intervention.

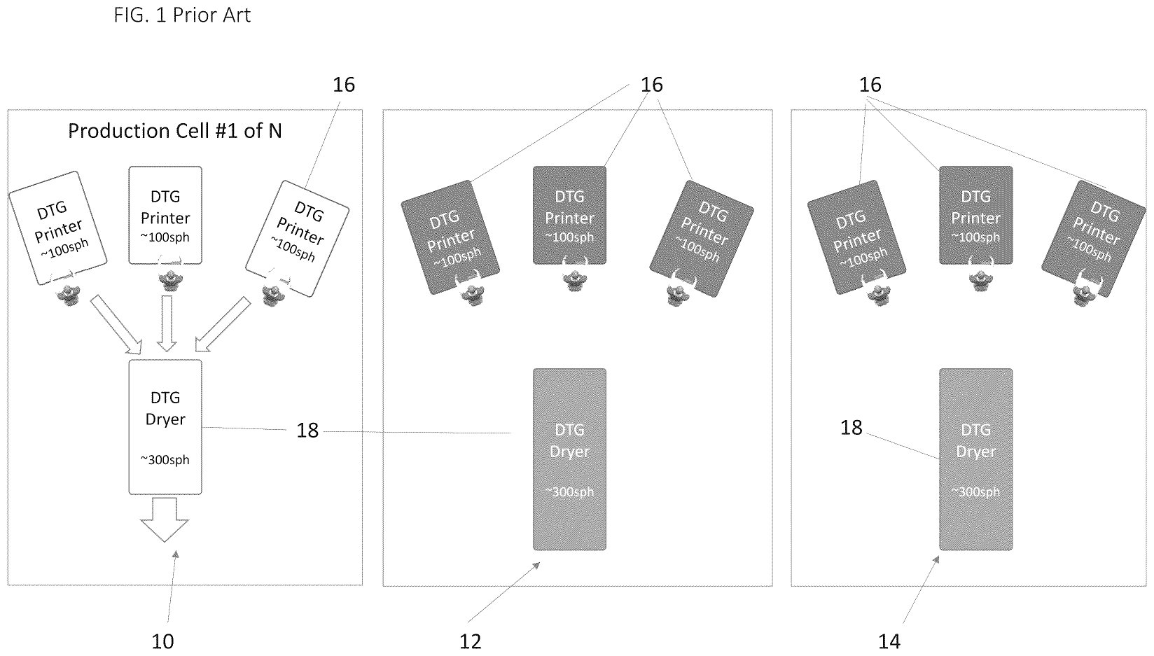

For purposes of better understanding some embodiments of the present invention, reference is first made to the construction and operation of a prior art system as illustrated in FIG. 1 and already referred to in the background.

As shown in FIG. 1, several production cells 10, 12 and 14 may be constructed, each cell including one or more direct to garment printers, 16. Here three printers are shown in each cell. The printers are clustered around the input to a direct to garment dryer 18.

Each cell thus constitutes a print line each using small-to-medium volume production systems that is the printer with additional facilities in their vicinity such as common dryer 18. As explained, a factory with a low production volume (orders) of around 1000 shirts per day may use one printer 16 and one dryer 18, which between them may handle approx. 100 shirts per hour over a 10-hour shift. If the orders are of medium volume of around 10,000 per day, the production line may need ten such printers operating in parallel. Several printers may use a single dryer as shown, and three production cells 10, 12 and 14 may be formed, each having three printers 16 and one dryer 18. The shirts need to be loaded on the printers and then transferred to the dryers. As explained above, since printing requires very precise registration, and the dryers are very hot, it is not possible to use the same pallets to carry the shirts directly from the printers to the dryer. Rather the shirts have to be unloaded from the precise room temperature pallets used by the printer and then transferred to the dryers.

This straightforward solution is very costly in both plant footprint of the equipment, that is the factory floor area required for all the printers and dryers, and the manpower to operate it, since each printer requires at least one human operator for the duration of any given operation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to FIGS. 2a and 2b, which are block views from the side and from above respectively, of a first embodiment of the present invention.

A pallet is provided at pallet lift up 20 to upper lateral conveyor 22. The conveyor conveys the pallet to garment loader 24 where a garment is collected from a stack or a batch, and placed on the pallet. The garment is conveyed to the printer 26 where printing and other associated operations may be carried out, such as various preprinting treatments. The pallet with the printed garment then proceeds to garment unloader 28, where if the feature is present, the neck-tag mechanism is released, and then the printed garment is removed. The pallet then proceeds to pallet lift down 30 where the pallet is lowered to the lower lateral conveyor 32 and returned to pallet lift up 20. The pallet is raised by the lift.

Reference is now made to FIGS. 3a and 3b, which are block views from the side and from above respectively, of an alternative embodiment of the present invention.

A pallet is provided at pallet lift up and unloader 40 to upper lateral conveyor 42. The conveyor conveys the pallet to garment loader 44 where a garment is collected from a stack or a batch, and placed on the pallet. The garment is conveyed to the printer 46 where printing and other associated operations may be carried out, such as various preprinting treatments. The pallet with the printed garment then proceeds to pallet lift down 48 where the pallet is lowered to the lower lateral conveyor 50 and returned to pallet lift up 40. The pallet is raised by the lift and the garment is released and removed by the unloader.

The architecture may thus be based on moving pallets in a horizontal manner through at least one functional module such as a printer, using an over-and-under conveying system, with at least one upstream elevator and at least one downstream elevator and a return conveyer between them.

The pallets may move on the conveying system between the different modules with or without the printed garments. In every cycle of the system the pallets stop at each functional station to perform the different functions of the complete printing sequence.

The present architecture may support one or more printing stations, for example to print different colors, and/or add additional decoration on the printed image. The different colors or decoration have to align precisely with each other and thus providing such features over different stations requires very high precision in the location of the pallets and printed media with reference to each station and the printing array, to ensure that the ink laydown is precisely at the required location on the media at each station.

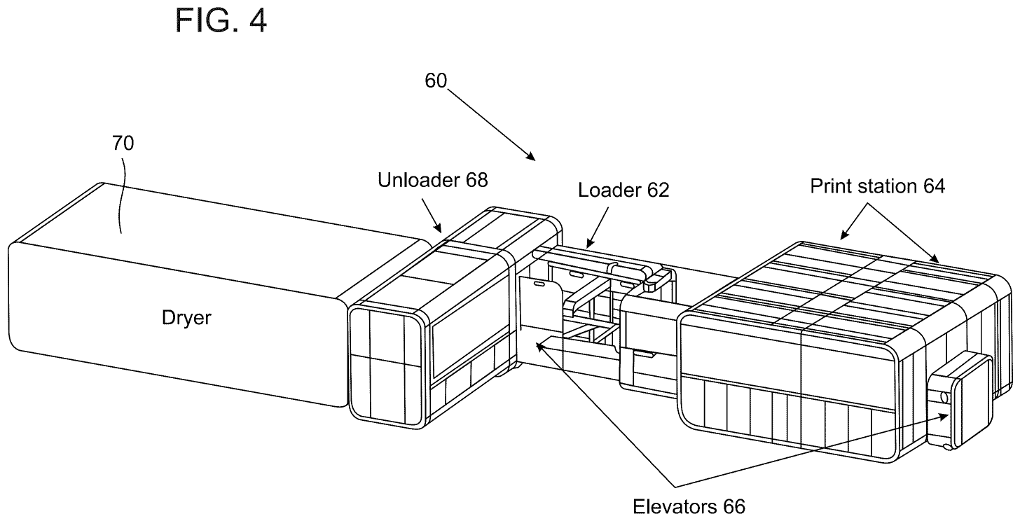

Reference is now made to FIG. 4, which is a diagram showing a perspective view of an embodiment of the present invention. A high volume printer 60 comprises a loader 62, print stations 64, elevators 66 at either end of the print stations, and an unloader 68. The upper and lower conveyors extend between the elevators 66 and are not visible in this view. A dryer 70 has its own conveyor and is linked to the unloader 68. Accordingly there is provided a continuous system for feeding the garments that starts with loader 62, takes the garments through the print stations 64 and then passes the garments through the dryer 70. However the garments are unloaded from the pallets prior to entering the dryer so that the high-precision location mechanisms used by the pallets are not damaged by the heat of the dryer.

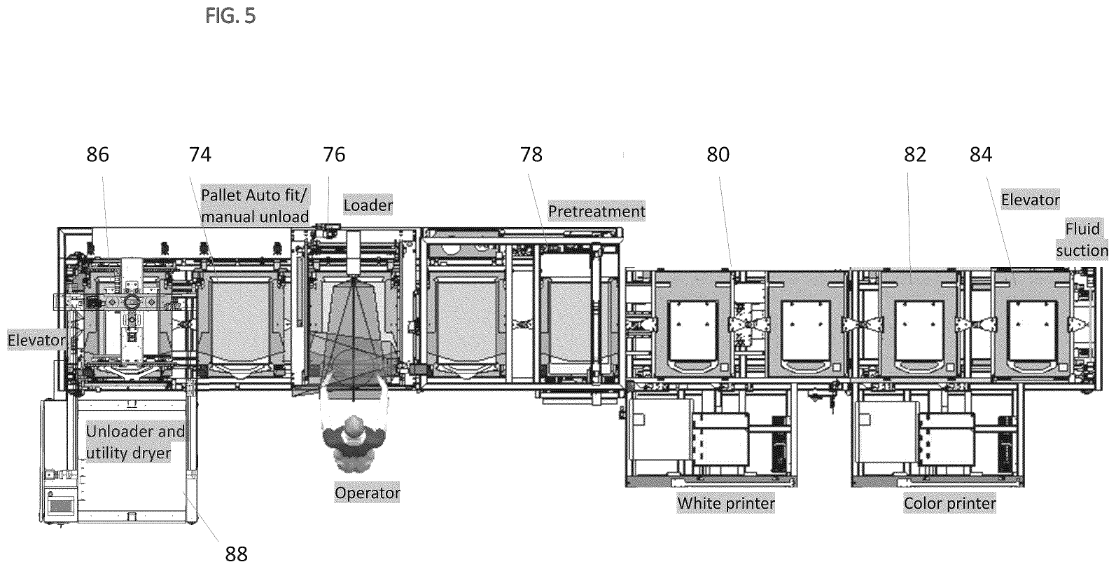

Reference is now made to FIG. 5, which is a simplified block diagram illustrating in greater detail a view from above of a printing system 72 according to the present embodiments. The various functional parts of the system may include a shirt loader station 74, which may be a manual station, a semi-automatic or even a fully automatic station, where the garments may be picked automatically from a stack. The loader may follow a pallet auto-sizing station 76, in which the mechanical configuration of the pallets are automatically or manually altered to support all printed garments forms and sizes. Thus a section may be added to increase the width of the pallet, or a shaped collar section may be added or removed or the like. A pretreatment station 78 may apply any pretreatment process before the printing phase, including but not limited to fixation fluid, heat press, heat pretreatment, etc. One or more printing stations may then apply digital printing including white and color inks on the garments. In the example illustrated, separate white 80 and color 82 printing stations are provided.

Following application of pretreatment fluids, for example fixation fluid, inks, etc.), a dedicated fluid management system may be provided to collect the excessive fluids from the system, either by direct drainage, or by forced suction to an external reservoir. Such a fluid management system is applicable to any embodiments herein.

A down elevator 84 then takes the pallet after printing to the lower conveyor. Optionally further stations may be provided along the lower conveyor.

A shirt unloader station may be provided, which may be either manual or automatic, and here is shown combined with the up elevator station 86. In an embodiment, an automatic unload station may be combined with the up elevator 86, and a manual load/unload station may be combined with the pallet auto-fit station 74. Thus automatic loading may be used for standard garments and manual loading and unloading may be used for non-standard or special garments which the automatic system does not know how to handle.

The lower pallet conveyer, not visible in this view, returns the pallets, with or without the garment, to their initial position. As mentioned, the lower conveyor may include additional functional stations to apply other functionalities to the printed garment.

The downstream elevator 84 moves the pallets downwards, from the upper conveyor to the lower conveyor, after printing.

The upstream elevator at station 86 moves the pallets upwards from the lower conveyor to the upper conveyor where an automatic unloader awaits to release and remove the printed garment and place it on the dryer.

The unloader at station 86 may be an automatic unloader that interfaces between the printer and the dryer, and may provide for multiple lane placement of the garments on the dryer belt 88. The dryer, which extends from the dryer belt 88, dries and cures the printed garments, and at the far end of the dryer there may be provided a station for post print handling-say including a folder for folding the garment, robot arms or the like for packaging, or placing the printed garments in storage, etc.

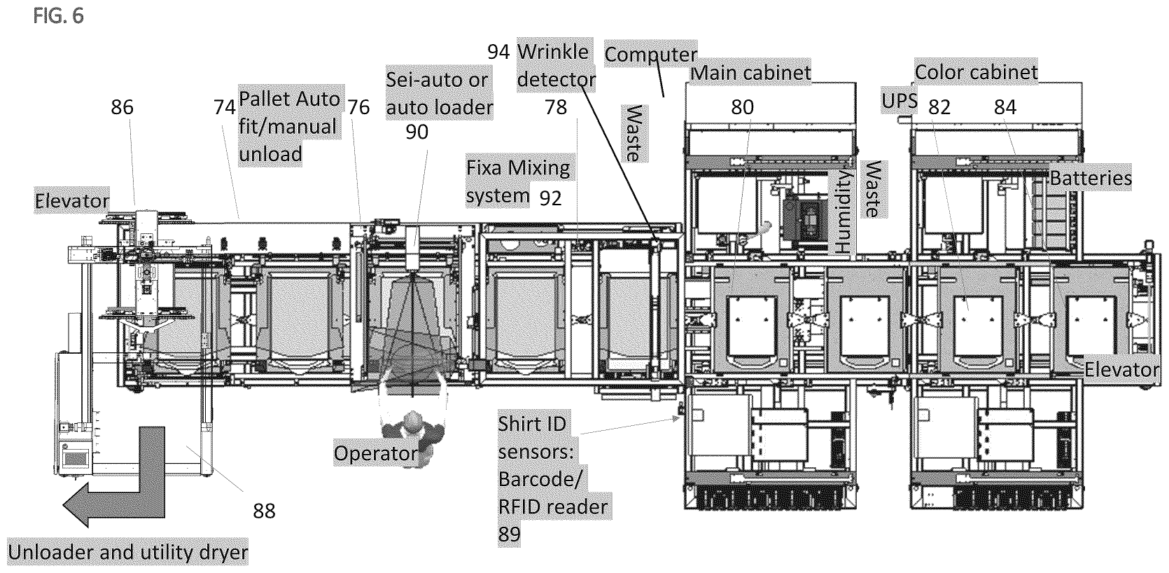

Reference is now made to FIG. 6 which is a more detailed view of the printing system of FIG. 5. Parts that are the same as in FIG. 5 receive the same reference numerals and are not described again except as needed for an understanding of FIG. 6.

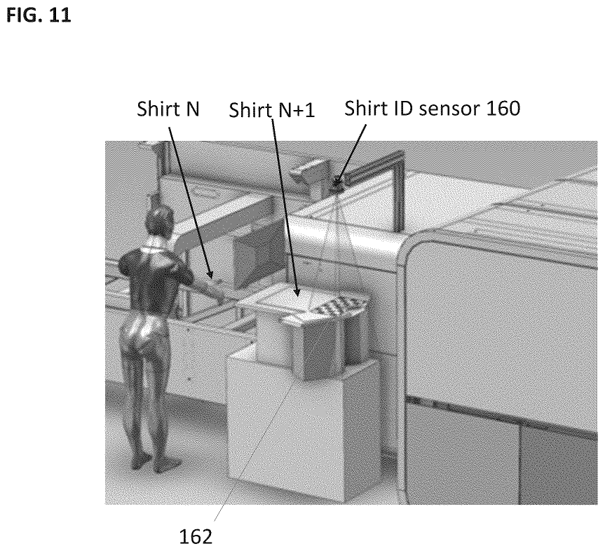

The garments arriving at the system may include barcodes or RFIDs that may indicate what types of garment they are or what printing operation is required. Thus the system may include a barcode or RFID reader 89 to read the code and set the system to carry out the required operation, as discussed in greater detail below in respect of FIG. 11.

A mixing system 92 may prepare a preprinting mixture as appropriate for the type of garment. Thus, for example, a woolen garment may require a different pre-printing mixture from a nylon garment.

A wrinkle detection system 94 may be added to check that the garments advancing towards the printer are indeed smooth. Upward wrinkles of folds may disrupt the printing process and further may act to foul the printing nozzles.

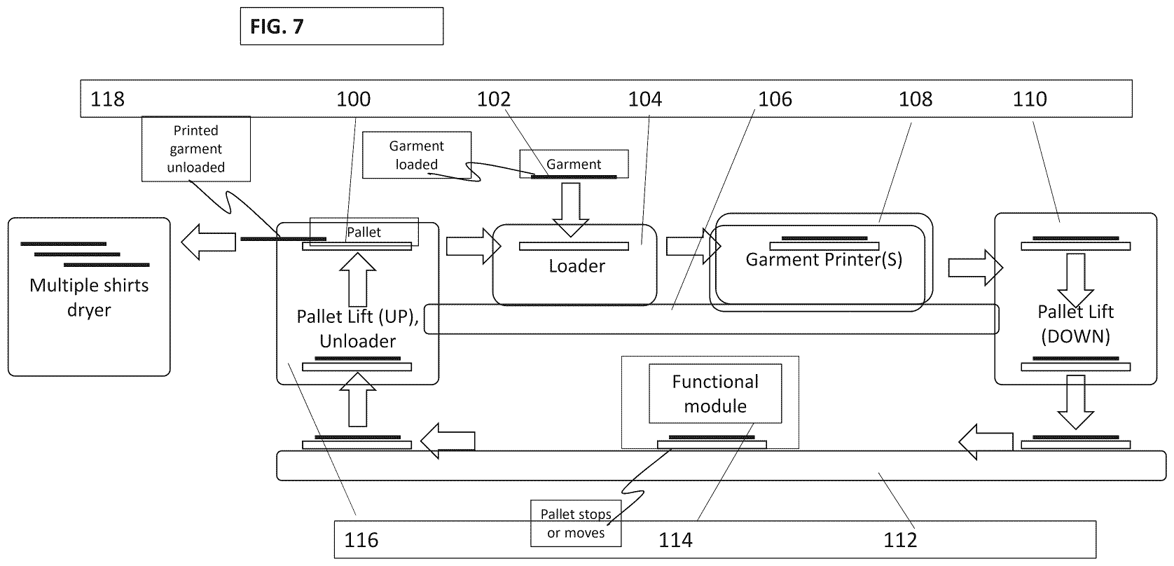

Reference is now made to FIG. 7, which illustrates a basic conveying circuit according to embodiments of the present invention. A pallet 100 is loaded with a garment 102 at loader 104 and proceeds on conveyor 106 to garment printer 108 where the various printing processes are carried out. The pallet then reaches the down lift 110 and is lowered to lower horizontal conveyor 112. The pallet is then conveyed via optional functional module 114 to up lift 116 and is unloaded and moved on to the multiple shirt dryer 118.

It is noted that, in embodiments the lower conveyor 110 may not include the precise registration mechanisms needed for digital printing, and thus the functional module 112 may be reserved for functions which do not require precise registration, for example spraying the entire garment with a post printing composition.

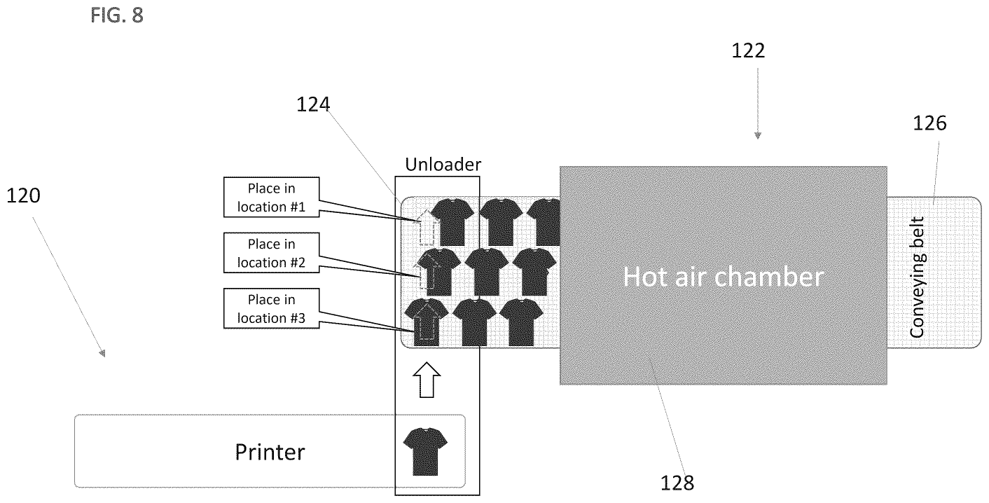

Reference is now made to FIG. 8, which is a simplified diagram illustrating the interface between the printer part 120 of the system and the dryer part 122 of the system. The interface to the dryer may for example be based on an automatic unloader 124 that releases the garments' neck-tag from the pallet, picks or unloads the printed garments from the pallets, moves them to the dryer, and places them on the dryer's belt in multiple lanes. The unloader may include one or more robot arms with grabber attachments to grab the garments at corners or the like to remove them from the pallets and place them flat on the conveyor belt 126 of the dryer 128. It is noted that the garment placing operation may be timed to fit with the throughput from the printer and the throughput through the dryer.

The dryer 128 may be a wide dryer with multiple lanes. Such a construction may reduce the dryer's length and overall footprint since multiple garments are dried simultaneously in the same chamber. However, such an arrangement requires a sophisticated unloader to place the garments in different locations on the belt over each cycle, hence the unloader movement is different over parts of the cycle.

As shown in FIG. 8 garments 130 reaching the end of the printer are picked up and placed on the conveyor 126. Succeeding garments are placed in successive locations #1, #2 and #3 across the conveyor. The conveyor advances continuously so that successive garments are staggered in the widthwise across the conveyor. The speed of the conveyor may be controlled so that for a width of n garments, in this case three garments, the conveyor moves 1/n garment widths for each garment placement. Accordingly the garments fit correctly next to each other in the lengthwise direction.

That is to say, the dryer's conveying speed and size calculation is derived from the printer's throughput, and such is possible since both the printer and the dryer are inline and synchronized with each other.

The printer produces a new printed shirt every Tp cycle time which is unloaded onto the dryer with N lanes. Each location on the belt is required to be clear for a new shirt within N*Tp (sec). The location width may equal the widest applicable shirt (W); So, the belt speed is V=W/N*Tp.

For example: Printer throughput=400 shirts per hour (sph), the equivalent of one shirt every 9 seconds. The number of dryer lanes=3 as shown, and the shirt maximum width=60 cm.

Accordingly, the belt speed=60/(3×9)=60/27=2.2 cm/sec˜135 cm/min

In turn, the belt speed defines the dryer length (L) in accordance with the overall drying time (Td): L=V*Td.

In the above example, if drying time is up to 4 minutes, the minimum dryer length is:

$$L = 135 * 4 = 540 cm ∼ 5.5 m .$$

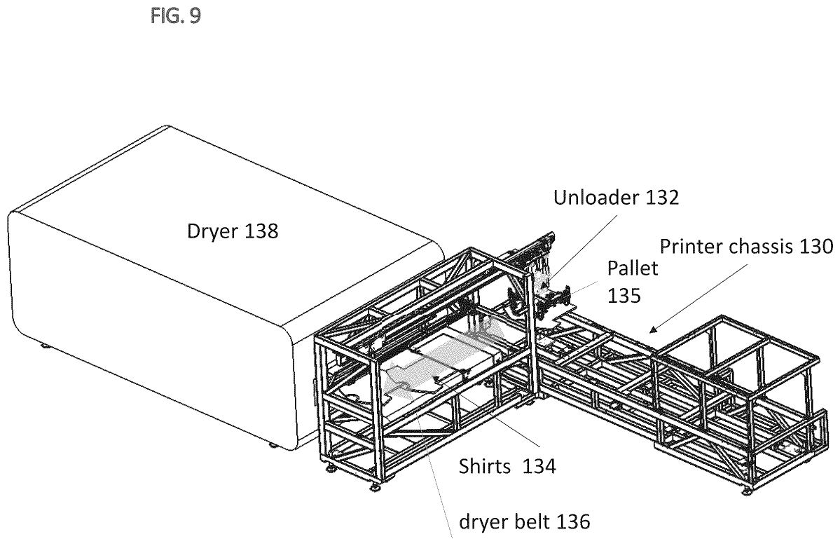

Reference is now made to FIG. 9, which is a simplified diagram showing a perspective view of the printer dryer interface according to embodiments of the present invention. Printer chassis 130 leads to the unloader 132. The unloader includes arms and grippers or any other suitable system for sliding garments 134 off the printing pallet 135 and placing them at one of the possible locations on conveyor belt 136 of dryer 138.

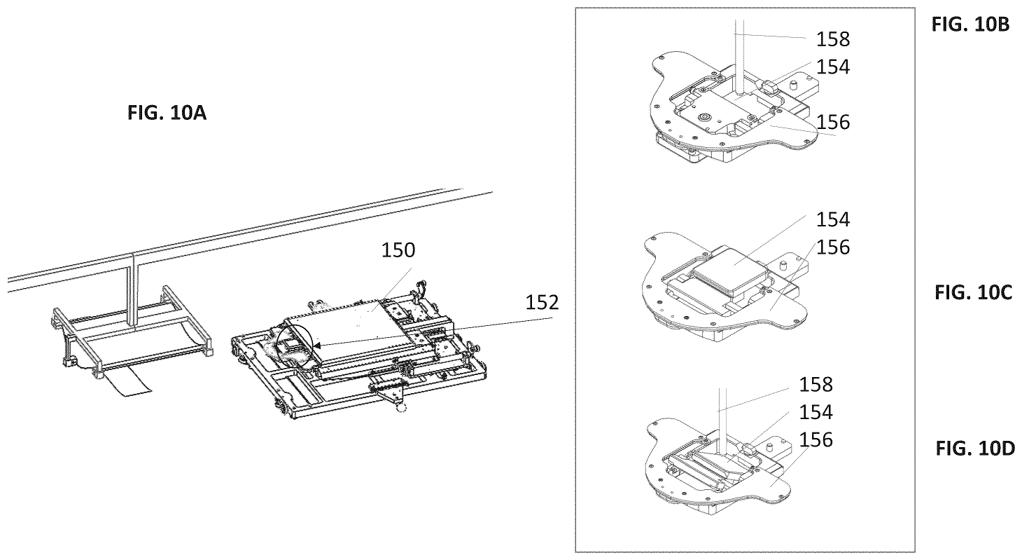

Reference is now made to FIGS. 10A-10D, which illustrate an implementation of an auto neck tag release mechanism. FIG. 10A shows a printing pallet 150 with a neck tag mechanism 152 that provides a raised surface for printing a neck tag that is attached to the garment. The mechanism comprises a printing surface 154 and a frame 156. In the loaded position for printing, as shown in FIG. 10C, the printing surface 154 is extended beyond the frame 156 so that the tag on the printing surface is flush with the printing surface of the main pallet. In the unloading state as shown in FIG. 10B, the printing surface 154 recedes below the surface of the frame to release the garment. The garment is printed in the loaded position and unloaded in the unloading position. In order to unload the garment from the printing pallet the unloading mechanism uses a gripper 158 to engage a release mechanism, such as a catch, on the neck tag mechanism 152 and accordingly release the garment.

Reference is now made to FIG. 11, which illustrates a barcode reader 160, which is integrated into the printing system and which reads data such as checked barcode pattern 62 which attached to individual garments. The barcode may identify the garment's type and its main characteristics, allowing the printer to print each garment in accordance with the data. In embodiments the data may be used to place the garment correctly on the drying belt. The reader being embedded within the system, contrasts with manually operated readers that are commonly used in front of the loading station. A reader according to the present embodiments may establish the information of the next (N+1) shirt with plenty of time to allocate and load necessary job data. The data may define the desired printing operation, for example indicating the material of the garment, the size or type of the garment and the print file to be used for printing. Accordingly, the data may be used to print each garment as needed in automatic fashion.

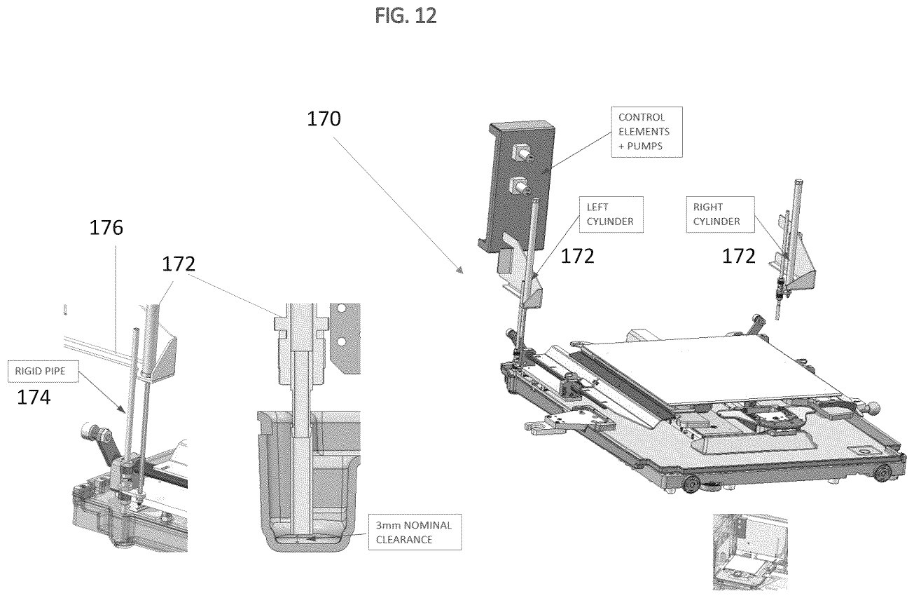

Reference is now made to FIG. 12, which illustrates a fluid management system for managing excess fluid that may appear at various points in the printing system, for example excess inks or excess pretreatment or posttreatment fluids. Following application of pretreatment fluids, for example fixation fluid, inks, etc.), a dedicated fluid management system may be provided to collect the excessive fluids from the system, either by direct drainage, or by forced suction to an external reservoir. Pumps may be provided at selected points around the printer where excess fluids may be expected, e.g., around and below the printing pallet. In some cases drainage holes may be sufficient, and depending on the liquid and the process, the waste liquid may either be collected for reuse or drained away. However a printing pallet moves and a drainage hole may be impractical. Thus a pump mechanism may be used. An excess fluid management system for excess fluids may include a suction system 170 which includes two cylinders 172, each combined with a rigid pipe 174 and attached to a frame 176. A control element 178 with pumps is attached to the frame 176, and a piston is provided to carry out suction. The cylinders are located above suction points and have a certain amount of clearance above the surface of the pallet to eliminate possible clogging by solid objects.

It is expected that during the life of a patent maturing from this application many relevant feeding, conveying and textile printing technologies will be developed and the scope of these and other terms are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A digital garment printing system for printing and drying of garments comprising:
a loading station for loading garments for printing onto pallets;
a conveyor;
at least one printing functional unit;
an unloading station;
a dryer; and
a drying belt for carrying said garments through said dryer after printing, wherein the unloading station comprises an automatic unloader for removing said garments from pallets and placing said garments on said drying belt.

2. The digital garment printing system of claim 1, wherein said loading station and said unloading station are on a same side of said printing functional unit.

3. The digital garment printing system of claim 1, wherein said conveyor comprises an upper conveyor and a lower conveyor, the system further comprising up lift for raising a pallet from said lower conveyor to said upper conveyor and a down lift for lowering a pallet from said upper conveyor to said lower conveyor, said up lift and said down lift being at respectively opposite sides of said printing functional unit and said upper conveyor and said lower conveyor each extending between said up lift and said down lift.

4. The digital garment printing system of claim 1, wherein the drying belt has a width to accommodate a first number of garments, said first number being greater than one, said drying belt being set at a speed to advance by one garment width during the time that said first number of garments is provided from said printing functional unit, thereby coordinating a drying speed with a printing speed.

5. The digital garment printing system of claim 4, wherein said drying belt is configured to advance continuously and said automatic unloader is configured to place successive garments at succeeding locations across said drying belt.

6. The digital garment printing system of claim 5, wherein said automatic unloader is configured with a gripper, the gripper being extensible to release a neck-tag printing mechanism prior to unloading the garment from the pallet.

7. The digital garment printing system of claim 4, wherein a length of said dryer is selected to provide garments a predetermined drying time when advancing through said drying on said drying belt at said drying speed.

8. The digital garment printing system of claim 1, further comprising a pallet resizing station, wherein pallets are altered in configuration to fit given garments.

9. The digital garment printing system of claim 1, further comprising heating and curing compartments in said dryer, said heating and curing compartments operating at respectively different temperatures.

10. The digital garment printing system of claim 1, further comprising a further printing functional unit located on said lower conveyor.

11. The digital garment printing system of claim 1, further comprising a reader for reading data supplied with garments, thereby to print each garment in accordance with said data.

12. A high speed digital garment printing method for printing and drying of garments comprising:
loading garments for printing onto pallets;
conveying said garments to a printing functional unit for printing;
unloading said garments from said pallets and placing onto a drying belt; and
drying said garments, wherein a speed of said drying belt is coordinated with garment printing production of said printing functional unit.

13. The method of claim 12, comprising loading and unloading on a same side of said printing functional unit.

14. The method of claim 12, comprising raising a pallet from a lower conveyor to an upper conveyor lowering a pallet from said upper conveyor to said lower conveyor, sad raising and said lowering being at respectively opposite sides of said printing functional unit.

15. The method of claim 12, wherein the drying belt has a width to accommodate a first number of garments, said first number being greater than one, and setting said drying belt at a speed to advance by one garment width during the time that said first number of garments is provided from said printing functional unit, thereby coordinating a drying speed with a printing speed.

16. The method of claim 15, comprising advancing said drying belt continuously and placing successive garments at succeeding locations across said drying belt.

17. The method of claim 15, wherein a length of said dryer is selected to provide garments a predetermined drying time when advancing through said drying on said drying belt at said drying speed.

18. The method of claim 12, further comprising altering a pallet configuration to fit given garments.

19. The method of claim 12, comprising operating separate heating and curing compartments in said dryer at respectively different temperatures.

20. The method of claim 12, comprising carrying out a printing or drying or deposition function on said lower conveyor.

21. The method of claim 12, further comprising reading data supplied with garments thereby to print each garment in accordance with said data.

22. The method of claim 12, wherein said loading garments comprises automatically or semi automatically loading the garments from a stack to the printing pallet.

23. A digital garment printing system for printing of garments comprising:
a loading station for loading garments for printing onto pallets;
a conveyor;
at least one printing functional unit;
wherein said conveyor comprises an upper conveyor and a lower conveyor, the system further comprising an up lift for raising a pallet from said lower conveyor to said upper conveyor and a down lift for lowering a pallet from said upper conveyor to said lower conveyor, said up lift and said down lift being at respectively opposite sides of said printing functional unit and said upper conveyor and said lower conveyor each extending between said up lift and said down lift wherein said lower conveyor comprising a second functional unit.

24. The digital printing station of claim 23, wherein said second functional unit is at least one member of the group consisting of a printing station, a drying station and a deposition station.
